(19) United States
(12) Patent Application Publication
(10) Pub. No.: US 2026/0094213 A1
(43) Pub. Date: Apr. 2, 2026

(54) Method to leverage Neural Networks and Large Language Models for Reliable Financial Forecasting, Analysis and Business Intelligence

(71) Applicant: Vignesh Ramachandran, Chennai (IN)

(72) Inventor: Vignesh Ramachandran, Chennai (IN)

(21) Appl. No.: 19/331,041

(22) Filed: Sep. 17, 2025

Related U.S. Application Data
(60) Provisional application No. 63/699,930, filed on Sep. 27, 2024.

(51) Int. Cl. G06Q 40/06; H04L 9/40

(52) U.S. Cl. CPC G06Q 40/0631; H04L 63/083

(57) ABSTRACT

A system and method for leveraging small language models and neural networks to perform reliable financial forecasting, analysis, and business intelligence. The invention integrates mind maps, retrieval-augmented generation, fine-tuned AI models, and high-security infrastructure to deliver accurate and explainable financial insights from natural language prompts. The mind maps can interact with a small language model to build artificial brain and logic layer. The small language model allows users to query financials using natural language and returns context-aware explanations. There is a Named Entity Recognition (NER) model that uses spaCy and runs in asynchronous execution. Retrieval-augmented generation (RAG) is used to enhance reliability of responses. The type of artificial intelligence includes machine learning, deep learning, and neural networks. There can be knowledge graphs for each financial caption with structured node relationships. Data security is enforced using authorization, JWT authentication, MFA, geo-fencing, and on-premise SLM training.

### FIELD OF THE INVENTION

The present invention relates to a method for leveraging artificial intelligence (“AI”), including neural networks and Small language models (“SLMs”), to perform reliable financial forecasting, analysis, and business intelligence. More specifically, it relates to systems and methods that utilize AI-driven analysis of structured and unstructured financial data through natural language queries.

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients or properties such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meanings of “a,” “an,” and “the” include plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Existing financial forecasting and analysis tools are often inaccessible to small and mid-sized businesses. Most tools require extensive integration with Enterprise Resource Planning Software (“ERPs”) and involve manual interpretation of data. An owner of a small business may not have the financial literacy to interpret the data properly. Furthermore, existing AI tools may generate hallucinated results and cannot provide explainable insights. AI hallucinations occur when a large language model (“LLM”), often a generative AI chatbot or computer vision tool, perceives patterns or objects that are nonexistent or imperceptible to human observers, creating outputs that are nonsensical or altogether inaccurate. This is very harmful to a user, who may just take a result at face value, when in fact that result is totally inaccurate.

### SUMMARY OF THE INVENTION

This invention solves these problems because it provides a system that integrates SLMs, mind maps, and machine learning techniques to offer accurate, explainable, and secure financial analysis and forecasting.

The invention is a comprehensive platform using an ensemble of SLMs, machine learning, and neural networks, enhanced with mind maps and retrieval-augmented generation (“RAG”). It allows users to input natural language queries and receive accurate financial insights. The system is hosted on geo-fenced, secure servers and incorporates fine-tuning, supervised learning, and hallucination prevention mechanisms.

The present invention provides a comprehensive system and method for financial statement analysis and forecasting. The system is designed to combine the strengths of statistical forecasting techniques with the interactive capabilities of an LLM, deployed on a secure, geo-fenced server, which existing products are not able to provide. This integration allows users to gain deeper insights into their financial data, interact with it through natural language prompts, and receive customized recommendations. The present invention is able to consistently provide accurate results that are helpful to users, because it does not hallucinate and does not provide inaccurate results.

With the advent of AI and machine learning technologies, there is a significant opportunity to enhance the accuracy and efficiency of financial analysis. Existing AI solutions, however, frequently suffer from issues such as data hallucination, where the models generate inaccurate or fabricated information. This invention seeks to address these challenges by providing a system that integrates robust statistical forecasting with an advanced, non-hallucinating LLM to deliver precise and reliable financial insights.

Financial data includes information on income, expenses, assets, liabilities and other such data, in numerical and text format, in potentially large volumes.

The present invention utilizes artificial intelligence (“AI”) and large language models in business intelligence applications and financial planning and analysis applications, which is unique in the financial industry. Even more unique is the use of a variety of AI models, such as machine learning, deep learning and neural networks.

The present invention also utilizes accurate and relevant training data, wherein new users are comparable to the users from which training data was created. Therefore, the present invention is not susceptible to sampling bias.

### BRIEF DESCRIPTION OF THE DRAWINGS

FIG. 1 is a drawing of Architecture of the AI-based Financial Forecasting System [Placeholder] according to various embodiments of the present disclosure.

FIG. 2 is a drawing of Mind Map Integration Flow according to various embodiments of the present disclosure.

FIG. 3 is a drawing of Data Security and Access Control according to various embodiments of the present disclosure.

FIG. 4 is a drawing of ML and DL model Architecture (Planner Arch) according to various embodiments of the present disclosure.

FIG. 5 is a drawing of examples of an LLM behaving correctly according to various embodiments of the present disclosure.

FIG. 6 is a drawing of architecture of a RAG methodology according to various embodiments of the present disclosure.

FIG. 7 is a drawing of a knowledge graph or mindmap according to various embodiments of the present disclosure.

FIG. 8 is a drawing of node relationship structure in the mindmap according to various embodiments of the present disclosure.

FIG. 9 is a drawing of overall architecture of the present invention according to various embodiments of the present disclosure.

### DETAILED DESCRIPTION OF THE INVENTION

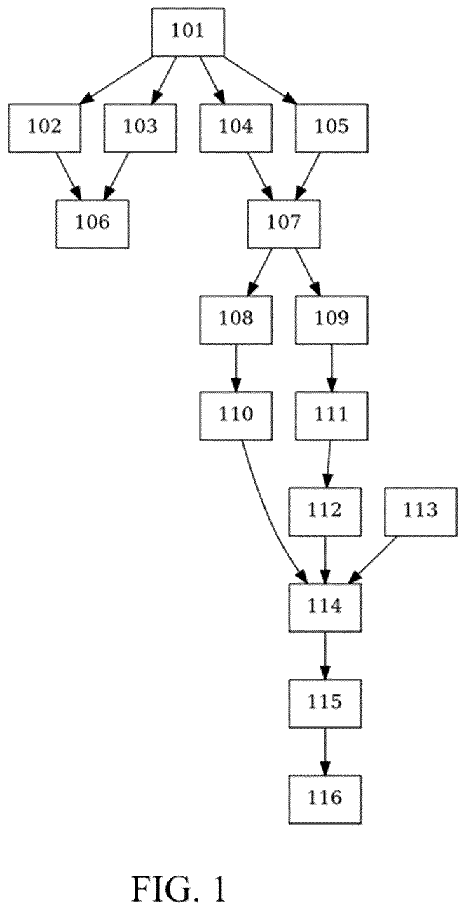

One embodiment of the present invention is displayed in FIG. 1. A user enters a prompt into user prompt 101. The user prompt 101 is taken in 4 different directions: General info 102, Definition 103, Analysis 104 and Calculation/Fetch 105. General info 102 and Definition 103 combine into a next step of BeRT caption detection plus neo4j query General info node and definition node 106. Analysis 104 and Calculation/Fetch 105 combine into Tokenizer/Sentence transformer 107. Tokenizer/Sentence transformer 107 splits into Fintelligence 108 and Finplan 109. Fintelligence 108 then goes to a next step of BeRT caption detection NER Timeperiod entity extraction 109. BeRT caption detection NER Timeperiod entity extraction 109 goes to the next step Test2SQL generation 110.

Finplan 109 goes to the next step Entity extraction (Caption, Financialrow, month/year, Intent) 111. Entity extraction (Caption, Financialrow, month/year, Intent) 111 goes to the next step Dispatcher (Selects SQL template based on INTENT) SQL Template function (Build Query plus parameters) 112. There is a separate step of User uploads Financial Documents 113. Test2SQL generation 110 and Dispatcher (Selects SQL template based on INTENT) SQL Template function (Build Query plus parameters) 112 and User uploads Financial Documents 113 merge to the next step Database Balancesheet, Incomestatement, Cashflow statement, Budget, Actuals, Forecasts, scenario 114. Database Balancesheet, Incomestatement, Cashflow statement, Budget, Actuals, Forecasts, scenario 114 goes to the next step Query results using SQL plus Params 115. Query results using SQL plus Params 115 goes to the next step SLM Model PHI 2 generates business summary 116.

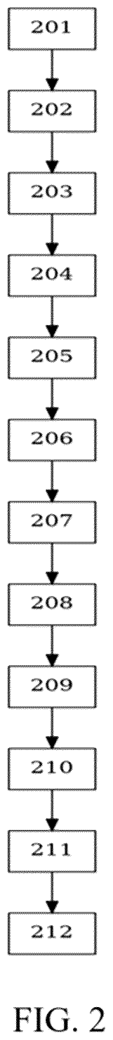

One embodiment of the present invention is displayed in FIG. 2. The invention detects a calculation 201. The next step is querying Neo4j for all Calculations for Caption 202. The next step is to encode calculation names & user prompt as embeddings 203. The next step is to compute cosine similarity between prompt & calculations 204. The next step is to filter calculations with valid formulas only 205. The next step is to sort calculations by score and select top-N calculations 206. The next step is to pick the best calculation (Top1) 207. The next step is to run a recursive evaluation of calculation node 208, including:
Query Neo4j for formula & dependencies
For each dependency:
   Evaluate recursively
   Fetch leaf data if base

The next step is to fetch leaf values from SQL using stored procedures 209. The next step is to substitute values in formula and safety compute result 210. The next step is to return final calculated value 211. The next step is to PHI 2 generates business summary 212.

Flask is a popular micro web framework for Python, widely used for building web applications and API services, including RESTful APIs. Its lightweight nature and flexibility make it a suitable choice for projects ranging from small-scale to moderately complex. MFA is multi-factor authentication. JSON is JavaScript Object Notation, a lightweight, text-based format for storing and exchanging data that is easily readable by humans and understood by machines. It is independent of programming languages and is used extensively in web development for transferring data between a server and a web application, as well as for storing data in files or databases. JWT is JSON web tokens. KMS is a key management service, a system for securely creating, storing, and managing cryptographic keys for encryption and decryption.

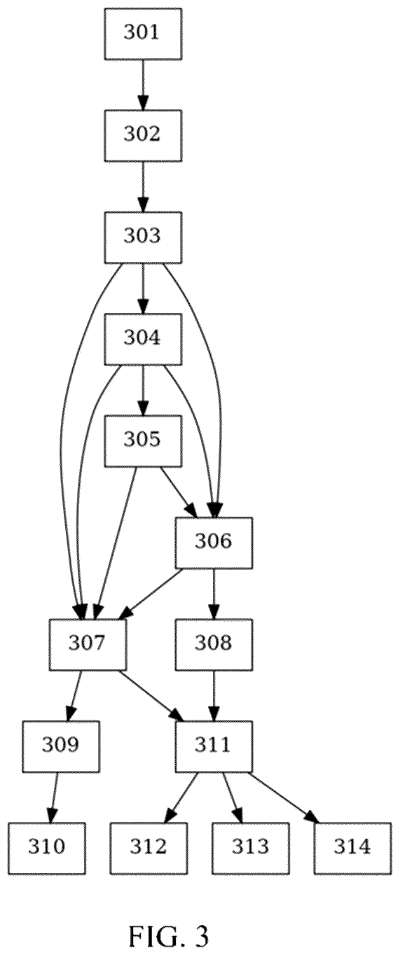

One embodiment of the present invention is displayed in FIG. 3. Here, the invention starts with end users on mobile or web 301. The next step is geo fenced access 302. The next step is WAF (ModSecurity/Cloud WAF) 303. The next step is Reach frontend via Nginx 304. The next step is Nginx Reverse Proxy 305.

The next step merges steps 303, 304 and 305 through https and splits it into Python API service (Flask) 306 and SLM Orchestrator (MFA, JWT) 307. Python API service (Flask) 306 includes backend service handling API requests and Security considerations, such as input validation using frameworks. SLM Orchestrator (MFA, JWT) 307 manages interactions with the Microsoft Phi AI model. Security considerations include MFA for admin and API access to prevent unauthorized orchestration. Python API service (Flask) 306 splits into 2, 1 goes through JWT to step SLM Orchestrator (MFA, JWT) 307, and the other goes through TLS to step MySQL 308. MySQL 308 includes a main database storing accounting and financial data. Security considerations include enabling at-rest encryption with InnoDB tablespace encryption.

SLM Orchestrator (MFA, JWT) 307 goes to step SLM Orchestrator (Prompt templates & Output filters) 309. SLM Orchestrator (Prompt templates & Output filters) 309 controls AI interactions to prevent prompt injection or data leakage. There are security considerations. SLM Orchestrator (Prompt templates & Output filters) 309 goes to step Object Storage/Backups 310, which stores files, backups and other large data. Security considerations include encrypting backups at rest and in transit. Both MySQL 308 and SLM Orchestrator (MFA, JWT) 307 go to the next step by fetching secrets, wherein the next step is Secrets manager/KMS 311. Secrets manager/KMS 311 stores and manages sensitive keys and credentials. Security considerations are to store API keys and DB credentials securely. Enable key rotation policies. Restrict access via IAM policies.

The features and benefits of the invention as described in FIG. 3 include Observability and incident response 312. Observability and incident response 312 includes logging, monitoring, and alerting system. Security considerations include collecting structured logs (JSON format), enabling APM (application performance monitoring), configuring SIEM (Security information and Event management) alerts for anomalies, and maintaining incident response playbooks. Another feature and benefit is Host & network security 313, which includes server and network hardening. Security considerations include disabling root SSH login, using key-based authentication, using firewalls (iptables/ufw) to restrict ports, and installing Fall2Ban to block brute-force. Another feature & benefit is Supply chain security 314. Supply chain security 314 protects against vulnerabilities in third-party dependencies. Security considerations include performing dependency scanning with tools like pip-audit, and requiring image signing for Docker.

The invention features a multi-layered architecture designed for intelligent financial data processing. At the foundation are base classifiers such as Support Vector Machines (“SVM”) and Logistic Regression, complemented by Natural Language Processing (“NLP”) models using Named Entity Recognition (“NER”) with spaCy (industrial strength natural language processing in Python. These feed into Text-to-SQL generation components and a Small Language Model (“SLM”), PHI-2, for producing narrative outputs. PHI-2 excels is a small, high-performance language model (SLM) developed by Microsoft Research that excels in common sense reasoning and language understanding. The RAG layer uses a Neo4j graph database to fetch grounded financial data. Security is implemented via JWT, MFA, and geo-fencing. The AI models run asynchronously in a cloud environment for real-time performance.

Various embodiments of the present disclosure relate to providing a Method to utilize artificial intelligence (“AI”) and large language models (“LLMs”) and leverage Neural Networks for reliable Financial Forecasting, Analysis and Business Intelligence.

Artificial intelligence is intelligence exhibited by machines, particularly computers. It includes software that enables machines to perceive their environment and uses learning and intelligence to take action that maximizes the chances of achieving defined goals. One form of AI is machine learning, which includes statistical algorithms that can learn from data and generalize to unseen data, and thus perform tasks without explicit instructions. Training data is sometimes provided so as to ensure that an AI software based on machine learning learns the right lessons. Another form of AI is neural networks, which is a model inspired by the structure of a brain. AI based on neural networks includes nodes called artificial neurons, which are modeled on neurons in the brain. These are connected by edges, which model synapses in the brain. Each artificial neuron receives signals from connected neurons, then processes them and sends a signal to other connected neurons. The “signal” is a real number, and the output of each neuron is computed by some non-linear function of the sum of its inputs, called the activation function. The strength of the signal at each connection is determined by a weight, which adjusts during the learning process. Typically, neurons are aggregated into layers. Different layers may perform different transformations on their inputs. Signals travel from the first layer (the input layer) to the last layer (the output layer), possibly passing through multiple intermediate layers (hidden layers). A network is typically called a deep neural network if it has at least 2 hidden layers. Machine learning that uses a deep neural network is called deep learning.

A large language model is a computational model notable for its ability to achieve general-purpose language generation and other natural language processing tasks such as classification. LLMs acquire these abilities by learning statistical relationships from vast amounts of text during a computationally intensive self-supervised and semi-supervised training process. LLMs can be used for text generation, a form of generative AI, by taking an input text and repeatedly predicting the next token or word.

The present invention utilizes artificial intelligence to make financial data understandable and provide consistent answers to queries from a user. Large language models are used to generate clear answers along with explanations of technical terms in conjunction with financial data, so as to give the user an understanding of what the data means and what its significance is.

Another embodiment of the present invention includes AI driven large language model developed to enable finance and non-finance management to prompt and talk to their financials. Another embodiment of the present invention includes a large language model (“LLM”) that sits in a secure cloud computing server that offers management and development of applications and services through a global infrastructure, which is enabled by an AI based software, which has been configured to logically engage with financial data.

The concept that is unique to this invention is the building of an artificial brain and logic layer based using mind maps that interact with a LLM, in order to enable a user to talk and interact with the financial data. Intense R&D has been conducted to link various nodes in the mind map that helps to connect and fetch/compute/calculate/analyze the required accurate answer for a given prompt. A node is a basic unit in a data structure or network that stores data and connects to other nodes whereas a mind map is a visual tool that organizes and represents knowledge or data hierarchically, facilitating understanding and analysis of complex relationships. It is exclusive to Tick and Tie and is not available in any LLM offerings from general AI providers. It encompasses various calculations and interrelationships across different categories.

In one embodiment of the present invention the AI based software produces a snapshot of financial health of a particular company across categories, cash, revenue, payroll, borrowing

In another embodiment of the present invention the AI based software produces and analyzes every line item of finance, profit and loss, balance sheet, cash flow statements, together financials

Every line item is scrutinized by the AI based software to provide a user useful intelligence. The LLM deep dives into the financials to provide a user additional insights that can be obtained using simple English queries from a user.

In another embodiment of the present invention the AI based software produces financial planning and analysis (FP&A), which helps in regards to forecasting of finance data, with budgeting, variance analysis, scenario analysis and what-if analytics.

This is a managed services model, wherein the present invention manages financial data and applies it in an application.

Alternative embodiments of the present invention utilize a medium language model or a small language model. Alternative embodiments of the present invention utilize either machine learning, deep learning, or neural networks. Alternative embodiments of the present invention utilize prompt engineering to design optimal prompts in order to provide a user useful feedback.

In another embodiment of the present invention, the output of a query from a user includes useful feedback, an explanation of financial terms, and an indication of whether the output is good or bad for the user or the user's company.

In another embodiment of the present invention, all analysis by the AI based software is done on cloud computing, utilizing servers that have high performance computer chips, such that the computer chips perform at speeds of 1-100 teraflops or over 100 teraflops. These servers with high performance computer chips are necessary to run AI based software that utilizes machine learning, deep learning, or neural networks.

### Implementation of the Machine Learning/Deep Learning/Neural Network Algorithm

Overview: Our innovation involves a sophisticated stack of machine learning (ML) and deep learning (DL) algorithms, leveraging ensemble methodologies to enhance model performance and accuracy. The ensemble approach involves combining multiple models to achieve better predictive performance than could be obtained from any of the individual models alone.

### INTRODUCTION

This patent introduces a system that uses advanced neural networks applications such as mind maps to interact with AI powered Large Language Models (LLMs) to process and analyze financial data stored in databases. The system can automatically generate queries to extract specific information from these databases based on user inquiries. It focuses on maintaining data privacy through secure server configurations and enhances query robustness by using both real and synthetic financial data. The goal is to provide accurate and actionable insights from complex financial datasets, presented in clear, understandable language similar to advice from a financial expert.

One Large Language Model (LLM), specifically the Codellama 34B model, is designed to generate SQL queries directly from financial statements stored in databases to respond to user queries. The Codellama 34B model undergoes fine-tuning on a geofenced server to ensure data privacy, leveraging a Synthetic Minority Over-sampling Technique (SMOTE) to generate 5000 synthetic data points related to financial statements. This diverse dataset enhances query diversity, ensuring robustness in query generation.

The Codellama 34B model is trained extensively in handling complex queries and adeptly identifies and prioritizes significant financial data points, demonstrating a high level of domain-specific knowledge acquisition. The model's output, consisting of SQL queries, is then processed by Gemma 7B, an ensemble partner LLM, to convert fetched results into coherent English sentences resembling advice from a financial advisor.

The present invention leverages an ensemble approach with two LLMs, Codellama 34B and Gemma 7B, to synergistically handle data processing and information synthesis tasks related to financial data queries, ensuring both accuracy and linguistic coherence in generating actionable insights.

### Summary Technique:

Ensemble Methodology: We employ a stacking ensemble methodology, wherein multiple base classifiers and models are trained separately, and their predictions are combined in a layered manner. This helps in leveraging the strengths of each model and mitigating their weaknesses.

### Example

Query: “A store has total Revenue of $15,000 and completed 500 transactions. What is the average transaction value?”, The system utilizes base classifiers to categorize the query. In this case, a base classifier identifies it as a calculation prompt, which then triggers a specialized caption classifier which predicts the Revenue. That specific caption calculation classifier is next triggered.

These calculation classifiers are trained to recognize various types of calculations beyond average transaction value, such as Expected Value, Net Profit Margin, Operating Expense to Revenue Ratio, and others. In response to the user query, the system correctly predicts “Average Per Unit” calculation. Concurrently, a Named Entity Recognition (NER) model extracts crucial entities like {“revenue”: 15000, “Number of transactions”: 500} from the query.

The predictions from the base classifiers, caption classifier, calculation classifier, and NER model are integrated through an ensemble approach and are given as input to the Graph.
Base Classifiers:
   Support Vector Machine (SVM): Used for classification tasks, providing a robust way to handle linear and non-linear data separations.
   Logistic Regression: Another classifier used in our stack, which is particularly effective for binary classification tasks.
Feature Embeddings:
   GloVe (Global Vectors for Word Representation): A pre-trained word embedding model that captures semantic meanings by mapping words into a continuous vector space.
   TF-IDF (Term Frequency-Inverse Document Frequency): A statistical measure used to evaluate the importance of a word in a document relative to a corpus, enabling effective text representation.
Named Entity Recognition (NER): We use an NER algorithm to extract entities from user input prompts. This is achieved through:
   Pretrained NER Models: We utilize pretrained models and fine-tune them with our labeled data using the spaCy library, enhancing the model's ability to accurately identify and classify entities in our specific context.

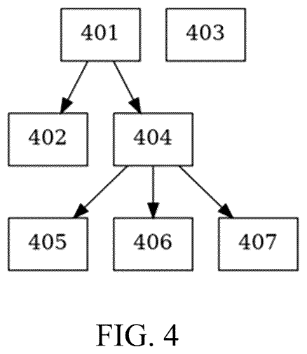

FIG. 4 displays a ML and DL model Architecture (Planner Arch). This diagram illustrates the architecture of a machine learning system designed to process financial text inputs efficiently. The system employs a combination of Named Entity Recognition (NER) and multiple classifier models, operating asynchronously to optimize performance. The following is an in-depth explanation of its architecture, its components, and its underlying methodologies.

### Named Entity Recognition (NER) Model

### Domain-Specific Model

The NER model is tailored for a financial domain, utilizing a pre-trained model to ensure high accuracy in entity extraction. For instance, consider the following prompt:

Prompt: A business generates $12,000 in revenue by selling 200 units. What is the average revenue per unit?

From this prompt, the NER model extracts the following entities: Entities: {“revenue”: $12,000, “units”: 200}

### Use of SpaCy

The implementation of the NER model leverages SpaCy, a robust natural language processing library. SpaCy's flexibility allows for creation of custom NER models. By training SpaCy's NER with financial datasets, the model becomes adept at recognizing entities relevant to financial calculations, such as “revenue” and “units.”

### Detailed Classifier Hub

1. Base Classifier
   Function: The base classifier determines whether the input prompt is a calculation prompt or a general question-answer prompt.
   Implementation: This classifier uses GloVe embeddings to represent textual data, capturing semantic relationships between words. Support Vector Machine (SVM) algorithms are employed due to their high accuracy, robustness to overfitting, and ability to handle high-dimensional spaces.
2. Calculation Classifier
   Function: If the base classifier identifies the prompt as a calculation prompt, it is forwarded to the calculation classifier. This model categorizes the type of calculation required, whether it's simple arithmetic or more complex financial computations.
   Implementation: Similar to the base classifier, it uses GloVe embeddings and SVM to ensure precise classification of calculation types.
3. Caption Classifier
   Function: If the prompt includes a caption, it is directed to the caption classifier. This model identifies the type of caption and the specific context it relates to.
   Implementation: This classifier also employs GloVe embeddings and SVM, leveraging the flexibility and accuracy of these tools to handle a variety of caption types.

The whole Planner runs in Asynchronous Execution. The architecture's design allows for asynchronous execution of the NER and classifier models. This means that each component processes the input independently and concurrently, significantly enhancing the system's speed and efficiency. Asynchronous execution is crucial for real-time applications, ensuring the system remains responsive and capable of handling multiple input prompts simultaneously.

2. Techniques to Prevent the LLM from Hallucinating

Overview: Preventing hallucinations—instances where the model generates plausible but incorrect or fictitious information—is critical for maintaining the reliability and accuracy of our LLMs. We employ two primary methodologies to mitigate this issue.

### Summary Techniques:

Fine-Tuning with Domain-Specific Data:
   Custom Dataset: We fine-tune our LLMs using a meticulously curated dataset that is specific to our domain. This process involves training the model on data that closely represents the types of inputs and outputs we expect the model to handle, thereby improving its accuracy and reducing the likelihood of generating irrelevant or incorrect information.
      For example below is our Instruction tuning training dataset. The strategy used to improve a model's performance on specific tasks is instruction fine-tuning. It's about training the LLM model using examples that demonstrate how the model should respond to the query.

###Schema:
CREATE TABLE derived_revenue(financial_row
VARCHAR(255) NULL, type VARCHAR(255) NULL, date
VARCHAR(255) NULL, document_number
VARCHAR(255) NULL, name VARCHAR(255) NULL, clr
VARCHAR(255) NULL, split VARCHAR(255) NULL,
amount FLOAT NULL, timeframe VARCHAR(255) NULL);
###Question:
List the top 5 revenue journals/invoices posted in FY2023.
###Instruct:
you are an mysql expert, Generate a SQL query to answer
the following question:
This query identifies the top 5 revenue-generating invoices or
journals in FY2023, filtering for significant transactions up to
June 2023, grouped and ordered by total revenue, for
company 1.
###Query:
select document_number, sum(amount) as Amount from
derived_revenue where timeframe = ““As of Jun 2023””
AND company_id=1 group by document_number order by
Amount DESC Limit 5;”

The training data plays a crucial role in educating the LLM server, particularly leveraging its capabilities as a Codellama 34B model, which is adept at handling complex query generation tasks. This model has already undergone extensive training to excel in understanding and navigating database schema architectures that are actively maintained.
Through exposure to diverse datasets, including financial statements, the Codellama 34B model acquires the ability to identify and prioritize significant data points, such as the top 5 revenue-generating journals or invoices within a specific timeframe, like FY2023. This skill is pivotal for financial analysis tasks, enabling the model to extract actionable insights efficiently.
Furthermore, the Codellama 34B model's training encompasses a formulation of SQL queries tailored to extract precise information from databases. Its proficiency in query generation ensures that it can construct queries optimally suited for retrieving financial data based on specified parameters, such as company identifiers.
By virtue of its advanced training in query generation and deep understanding of database structures, the Codellama 34B model not only enhances its adaptability but also significantly boosts its efficacy in supporting strategic decision-making processes. This makes it a valuable asset for applications requiring robust data analysis and insights extraction from complex datasets.
Retrieval-Augmented Generation (RAG):
   Neo4j Graph Database: We integrate a graph database (Neo4j) to enhance the model's ability to access and utilize structured information.
   Information Retrieval: When a query is made, instead of relying solely on generative capabilities of the LLM, the model retrieves relevant information from the graph database. This ensures that responses are grounded in accurate and up-to-date data, reducing the chances of hallucination.

By combining these methodologies, we significantly enhance the reliability of our LLMs, ensuring that outputs are both relevant and accurate, aligned with all expectations and requirements of our application domain.

Fine-Tuning with Domain-Specific Data:

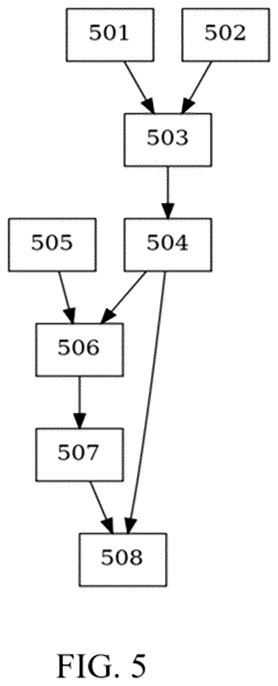

The present invention fine-tunes with help from SFT. Supervised fine-tuning (SFT) is the first training step within the alignment process for LLMs. First, the present invention curates a dataset of high-quality LLM outputs—these are examples of the LLM behaving correctly; see FIG. 5. Then, we directly fine-tune the model over these examples. Here, the “supervised” aspect of fine-tuning comes from the fact that we are collecting a dataset of examples that the model should emulate. Then, the model learns to replicate the style² of these examples during fine-tuning.

### Below are the Steps of Fine-Tuning LLM:

1. Generate the Synthetic data set. From the sample given prompts we generate 5K sample prompts for one caption using langchain synthetic data generation.
2. Preparing the fine tuning dataset:

Data collection: Convert the generated data into Instruction tuning format. Below is the Instruction that describes a task, paired with an input that provides further context. Write a response that appropriately completes the request.

### Instruct : {instruction}
### Input: {input{
### Response:
Data cleaning: Using sbert (sentence transformers) found whether there is
redundant data due to synthetic data generated above to avoid overfitting. Also a
user can manually look at most prompts if a generated query is correct with a
SQL subject matter expert (“SME”).

3. Setting Up the Training Environment:
   a. Infrastructure: Due to the size of the 34B model, you'll need substantial computational resources, Spinned up A100 graphics processing unit (“GPU”).
   b. Frameworks: Utilize machine learning frameworks like PyTorch or TensorFlow that support large-scale model training and fine-tuning.
4. Fine-Tuning Process:
   a. Initialization: Load the pre-trained CodeLlama 34B model weights in FP8.
   b. Custom Training Loop: Implement a training loop that will iterate over your fine-tuning dataset. During each iteration, the model processes input data, computes the loss, and updates the model parameters using backpropagation.
   c. Loss Function: Choose an appropriate loss function based on your task. For code generation tasks, Cross-Entropy Loss is commonly used.
   d. Optimization: Used Adam optimizer, which is well-suited for training our large-scale transformer models.
   e. Hyperparameters: Below are the hyperparameters, after doing some benchmarking we found the below are the best hyperparameters that best fits for the data.
      i. Keeping the precision in FP8.
      ii. Batch_size=2
      iii. Optimizer= “adamw”
      iv. Learning_rate=2e∧−4
5. Post-Processing:
   1. Model Saving: Save the fine-tuned model weights and tokenizer.
   2. Inference: Hosted the fine-tuned model in tensorrt and deployed in the triton server. Which now basically gives higher performance compared to other hosting servers.

### Retrieval-Augmented Generation (RAG):

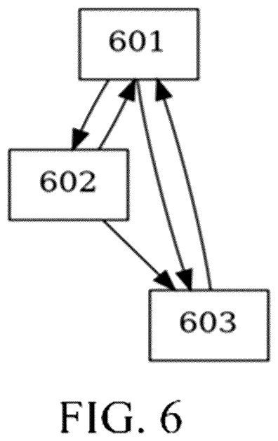

FIG. 6 illustrates the architecture of a RAG methodology. Below is the ideology of the Graph:

### Graph Ideology

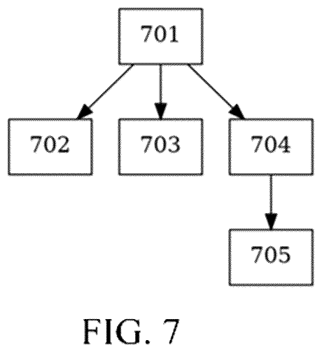

The graph part of the system, known as a knowledge graph or mindmap, is implemented using Neo4j Aura DB. It consists of all retrieval-related information in a node relationship structure. Each caption has its own mindmap, comprising theoretical information, analytical information, and calculations related to that caption. It is displayed in FIG. 7.

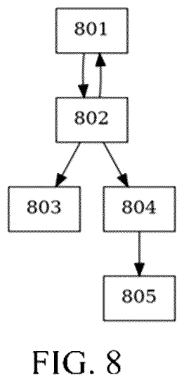

Please find the node relationship structure in the mindmap based on the categories: General, caption, Analysis/Ch, Calculation and Variables/Depend. This is displayed in FIG. 8. Relevant information is available in the nodes. A node is a fundamental data structure that represents entities. Each node can have various properties, which are key-value pairs that provide more detailed information about the entity the node represents. Here are the primary properties and characteristics of nodes in Neo4j:

### Labels:

Labels are used to categorize nodes. A node can have one or more labels.

### Properties:

Properties are key-value pairs associated with nodes. They store attributes of the node.
The key is a string, and the value can be of various types including string, integer, float, boolean, array, or null.

### Node ID:

Every node has a unique identifier (ID) assigned by Neo4j when the node is created. This ID is used internally and can be used to reference the node.

### Relationships:

Nodes can be connected to other nodes via relationships. While relationships are not properties of nodes, they are essential in defining how nodes are interconnected in the graph.

The node labels defined in the Architecture contain different sets of properties to differentiate each. For example,
1. Definition of the node
2. Information about the node
3. A formula for calculation
4. Dependencies (prerequisites required for the calculation)
5. Evaluation properties that connect with a code base to evaluate certain variables required for calculation.
6. Other essential keys that are necessary for navigation.
What procedure is happening on the nodes, that is used to avoid hallucinations?

Upon receiving a prompt, the required information is extracted to determine the nature of the question. The prompt is classified as logical question answering, definition-based, analytics-based, calculation-based, or data retrieval.

If the prompt involves a calculation, the following steps are taken:
1. Identify the specific calculation required.
2. Locate the relevant calculation node from the knowledge graph.
3. Extract the formula and its dependencies.
4. Determine where the dependencies need to be fulfilled-whether they are provided in the prompt or need to be calculated using existing data.
5. Evaluate the procedures for fulfilling the dependencies, execute them, and store the variable values.
6. Apply these variable values to the formula and execute it to obtain the results.

Since backend data is validated and the formula is predefined, the chances of hallucination or incorrect answers are eradicated.

If the prompt is based on general question answering, based on the caption under which it is classified,
Identify the respective caption node based on the classification.
Locate the general information node associated with this caption.
Use the information present as a property in the node as input data in the LLM along with the prompt to fetch the answer from the node.

General Information: In this context, all theoretical and logical information about a caption will be stored in connection with the caption. Any theoretical or logical questions will be answered solely based on this stored information, ensuring that no unwanted information causes hallucination.

Analysis/Charts: Each caption has a predefined set of analytical charts with specific rules and regulations. These rules and regulations are fed into the nodes, which can be retrieved when prompted.

Calculation: Each caption has a predefined set of calculations expected to be prompted. All formulas, definitions, dependencies, and procedures required for each calculation are all fed into the mindmap of each caption. This ensures that calculated answers are accurate, as the formula and procedure for each calculation are predefined and cannot be incorrect.

Note: There is no redundancy in the creation of nodes, every node is created exactly once and connects with necessary properties over the relationship.

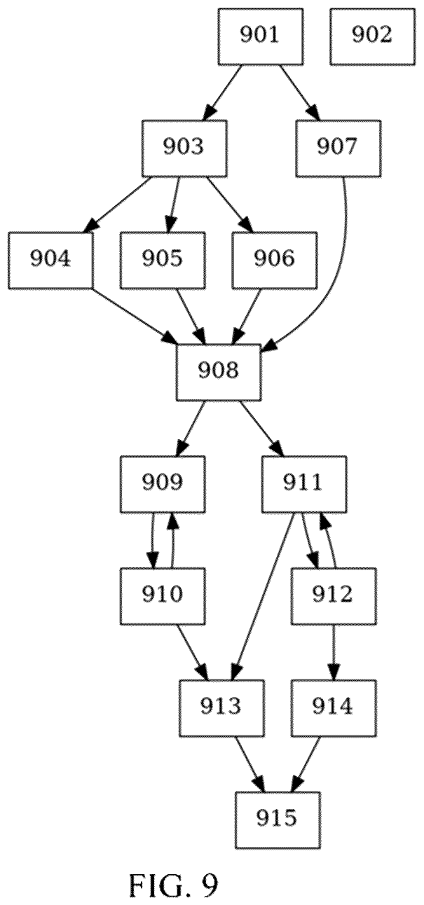

OVERALL Architecture is displayed in FIG. 9.

### Feature Development:

RLHF—The system we are building is also tracking the feedback from the users as well as the testing team. These incorrect predictions of the models are accumulated in the database as a batch. The batches are trained to see if the accuracy is increased that the previous once with our validation functionality. If the model accuracy seems to have increased by 3 times of epsilon then it auto-deploys the newer model which makes the system adapting to the current model.

### Data Security

### Data Security Implementation

### 1. Authorization and Authentication

Our system employs robust authorization and authentication mechanisms to ensure that only authorized users can access the product's features and data.

Authorization: This process determines what an authenticated user is allowed to do. Each user is assigned a set of permissions based on their role within the system. These permissions dictate the specific actions a user can perform and the data they can access. For example, an admin might have full access to all features and data, while a standard user might have limited access.

Authentication: This process verifies the identity of the user trying to access the system. The invention utilizes a multi-factor authentication (MFA) approach, which combines something the user knows (e.g., a password) with something the user has (e.g., a smartphone app or a hardware token) and something the user is (e.g., biometric data). This layered approach significantly reduces the risk of unauthorized access.

### 2. JWT-Based API Authorization

Every API endpoint within our system is protected using JSON Web Tokens (JWT). This ensures that each API request is authenticated and authorized before it is processed.

JWT Authentication: When a user logs in, the system generates a JWT that encodes the user's identity and permissions. This token is then used to authenticate subsequent API requests. The token includes a digital signature, which allows the server to verify the token's integrity and authenticity.

JWT Authorization: Each API request must include a valid JWT in the authorization header.

The server decodes and validates the token, checking the user's permissions against the requested resource. If the token is valid and the user has the necessary permissions, the request is processed; otherwise, it is rejected.

### 3. Geo-Fenced Servers

Our servers are geo-fenced, meaning they are restricted to operate within specified geographical boundaries.

Geo-Fencing Implementation: We use IP-based geo-fencing technology to ensure that our servers can only be accessed from certain geographic locations. This adds an additional layer of security by preventing unauthorized access from outside these designated areas. This is particularly useful for complying with regional data protection regulations and reducing the risk of cyber-attacks from foreign entities.

Server Location Control: The physical servers are also strategically located within secure, geographically diverse data centers. Access to these servers is controlled both logically and physically, with measures such as biometric access controls, surveillance systems, and regular security audits.

### 4. On-Premise LLM Training

To enhance data security, our large language models (LLMs) are trained exclusively on-premise, rather than using global APIs.

On-Premise Training: All machine learning models are downloaded to our secure, on-premise servers where they are trained using private data. This eliminates the need to send sensitive data over the internet to third-party providers, thereby significantly reducing the risk of data breaches and unauthorized access.

No Global API Usage: By avoiding global APIs, we ensure that our data remains within our secure infrastructure. This not only protects against data leakage but also ensures compliance with data sovereignty laws and regulations, which mandate that certain types of data remain within specific geographic locations.

Data Isolation: The training data is isolated within our secure environment, and strict access controls are implemented to ensure that only authorized personnel can access and manage this data. Additionally, all data is encrypted both in transit and at rest, further safeguarding it from potential threats.

Additional embodiments are listed below, and any embodiment may be combined with any one or more other embodiments.

One embodiment of the invention is a method to leverage neural networks and large language models for reliable financial forecasting, analysis, and business intelligence using artificial intelligence (AI)-based software and small language models (SLM).

Another embodiment of the invention includes mind maps that interact with an SLM to build an artificial brain and logic layer.

Another embodiment of the invention includes wherein the AI-based software scrutinizes every financial line item to provide useful insights.

Another embodiment of the invention includes wherein the SLM allows users to query financials using natural language and returns context-aware explanations.

Another embodiment of the invention includes wherein the type of artificial intelligence includes machine learning, deep learning, and neural networks.

Another embodiment of the invention includes further comprising a Named Entity Recognition (NER) model that uses spaCy and runs in asynchronous execution.

Another embodiment of the invention includes wherein retrieval-augmented generation (RAG) is used to enhance reliability of responses.

Another embodiment of the invention includes wherein supervised fine-tuning (SFT) is used to adapt SLMs to domain-specific queries.

Another embodiment of the invention includes further comprising knowledge graphs for each financial caption with structured node relationships.

Another embodiment of the invention includes wherein data security is enforced using authorization, JWT authentication, MFA, geo-fencing, and on-premise SLM training.

Another embodiment of the invention includes a method to leverage large language models for reliable financial forecasting, analysis, and business intelligence using artificial intelligence (AI)-based software.

Another embodiment of the invention includes mind maps that interact with an SLM to build an artificial brain and logic layer.

Another embodiment of the invention includes wherein the AI-based software scrutinizes every financial line item to provide useful insights.

Another embodiment of the invention includes wherein a SLM allows users to query financials using natural language and returns context-aware explanations.

Another embodiment of the invention includes wherein the type of artificial intelligence includes machine learning, deep learning, and neural networks.

Another embodiment of the invention includes further comprising a Named Entity Recognition (NER) model that uses spaCy and runs in asynchronous execution.

Another embodiment of the invention includes wherein retrieval-augmented generation (RAG) is used to enhance reliability of responses.

Another embodiment of the invention includes wherein supervised fine-tuning (SFT) is used to adapt SLMs to domain-specific queries.

Another embodiment of the invention includes further comprising knowledge graphs for each financial caption with structured node relationships.

Another embodiment of the invention includes wherein data security is enforced using authorization, JWT authentication, MFA, geo-fencing, and on-premise SLM training.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them.

The term “processor” encompasses all kinds of apparatus, devices, and machines for processing data, including by way of example a programmable processor, a computer, a system on a chip, or multiple ones, or combinations, of the foregoing.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method to leverage neural networks and small language models for reliable financial forecasting, analysis, and business intelligence using artificial intelligence (AI)-based software and small language models (SLM).

2. The method of claim 1, further comprising a multi-layered classification system that processes natural language queries through caption classification, calculation type detection, and entity recognition to build intelligent financial analysis workflows.

3. The method of claim 1, wherein the AI-based software scrutinizes every financial line item through comprehensive SQL query generation, data extraction, and business intelligence analysis to provide useful insights.

4. The method of claim 1, wherein the SLM allows users to query financials using natural language and returns context-aware explanations.

5. The method of claim 1, wherein the type of artificial intelligence includes machine learning, deep learning, and neural networks, and transformer-based models (Microsoft Phi 3).

6. The method of claim 1, further comprising a Named Entity Recognition (NER) model that uses spaCy and custom trained models for financial entity extraction and classification.

7. The method of claim 1, wherein retrieval-augmented generation (RAG) is used to enhance reliability of responses.

8. The method of claim 1, wherein sentence transformers and embedding-based similarity matching is used to enhance calculation selection and caption classification reliability.

9. The method of claim 1, wherein supervised fine-tuning (SFT) is implemented through custom trained models to adapt SLMs to financial domain-specific queries and calculations.

10. The method of claim 1, further comprising knowledge graphs for each financial caption with structured node relationships, calculation formula and procedure mappings.

11. The method of claim 1, wherein data security is enforced using authorization, JWT authentication enforced using company and user isolation in caching systems, MFA, geo-fencing, and on-premise SLM training and comprehensive security logging and monitoring.

12. A method to leverage small language models for reliable financial forecasting, analysis, and business intelligence using artificial intelligence (AI)-based software; and
wherein the AI-based software scrutinizes every financial line item to provide useful insights through multiple processing pipelines including budget analysis, forecast generation, and variance calculations to provide useful insights.

13. The method of claim 12, further comprising mind maps that interact with an SLM to build an artificial brain and logic layer.

14. The method of claim 12, wherein a SLM allows users to query financials using natural language and returns context-aware explanations.

15. The method of claim 12, wherein the type of artificial intelligence includes machine learning, deep learning, and neural networks.

16. The method of claim 12, further comprising a Named Entity Recognition (NER) model that uses spaCy and runs in asynchronous execution.

17. The method of claim 12, wherein retrieval-augmented generation (RAG) is used to enhance reliability of responses.

18. The method of claim 12, wherein supervised fine-tuning (SFT) is used to adapt SLMs to domain-specific queries.

19. The method of claim 12, further comprising knowledge graphs for each financial caption with structured node relationships.

20. The method of claim 12, wherein data security is enforced using authorization, JWT authentication, MFA, geo-fencing, and on-premise SLM training.

21. A method to leverage small language models for reliable financial forecasting, analysis, and business intelligence using artificial intelligence (AI)-based software;
wherein the AI-based software scrutinizes every financial line item to provide useful insights;
wherein mind maps interact with an SLM to build an artificial brain and logic layer;
wherein a SLM allows users to query financials using natural language and returns context-aware explanations;
wherein a Named Entity Recognition (“NER”) model that uses spaCy and runs in asynchronous execution;
wherein the NER model extracts entities from user input prompts;
wherein supervised fine-tuning (“SFT”) is used to adapt SLMs to domain-specific queries;
wherein retrieval-augmented generation (RAG) is used to enhance reliability of responses;
wherein logistic regression is utilized for binary classification tasks; and
wherein the type of artificial intelligence includes machine learning, deep learning, and neural networks.
